(19) United States
(12) Patent Application Publication
(10) Pub. No.: US 2010/0315480 A1
(43) Pub. Date: Dec. 16, 2010

(54) METHOD AND APPARATUS FOR USER ASSOCIATION AND COMMUNICATION IN A WIDE AREA NETWORK ENVIRONMENT

(76) Inventor: Mark Kahn, Encino, CA (US)

Correspondence Address: PATENT VENTURE GROUP, 10788 CIVIC CENTER DRIVE, SUITE 215, RANCHO CUCAMONGA, CA, 91730, US

(21) Appl. No.: 12/485,460

(22) Filed: Jun. 16, 2009

(51) Int. Cl. H04N 7/14; G06F 17/30

(52) U.S. Cl. 348/14.04; 709/227; 348/E07.078; 707/770; 707/912; 707/955; 707/812

(57) ABSTRACT

An invention is provided for allowing user association in a computer environment. The invention includes a central server having a subscriber database, the subscriber database storing a plurality of subscriber data entries, each subscriber data entry including characteristics of a related subscriber. The system also includes a plurality of user association and communication devices. Each user association and communication device is associated with a user database that stores calling criteria data indicating preferred characteristics of subscribers. In use, the central server facilitates a calling connection between at least two user association and communication devices based on the calling criteria data stored in a user database and characteristics stored in the subscriber database.

### BACKGROUND OF THE INVENTION

1. Field of the Invention

This invention relates generally to communication, and more particularly to methods and apparatuses for associating users to other users and providing user communication.

2. Description of the Related Art

Today's technology, such as email and text messaging, has facilitated communication around the world in a manner that was only dreamed of a few decades ago. Unfortunately, for those who do not understand the many nuances of such technology, this same technology has, in many cases, taken away much of the personal contact that existed in prior decades. This is particularly the case with many of our elderly citizens and other people who are confined to their homes.

Not only is this a problem today, but as the population ages, this will become increasingly more problematic. Often, as children are unable to stay home and keep their aging parents company, the parents begin to feel abandoned and alone. Moreover, our elderly generation often is not familiar or comfortable using much of the more complicated technology that is currently available to provide communication between people. For example, many websites currently exist that provide methods for getting people in contact with one another, but these websites generally require familiarity and proficiency with using personal computers. The same is true for many cell phone applications, which often require even more specialized technology proficiency for each particular phone or device on which they are operated.

Although such individuals generally are proficient using common telephones for communication, common telephones do not provide the face-to-face visual experience often desired between two individuals. Furthermore, common telephones do not allow an individual to find someone new to talk with. That is, when using a common telephone, an individual generally must know a particular person's telephone number, or have it preprogrammed into the phone, in order to contact someone.

In view of the forgoing, what is needed is a method to create a dialog between people who may feel isolated, alone, and depressed. The method should be able to create face-to-face communication between people, and should provide mechanisms to create new connections and friendships between similarly situated individuals.

### SUMMARY OF THE INVENTION

Broadly speaking, the present invention addresses these needs by providing a user association and communication device that allows communication in an online environment. In addition to allowing contact with know individuals, groups, and services, embodiments of the present invention allow users to find and communicate with new individuals that the user has never contacted before. Such association is based on calling criteria and preference data associated with the individual that indicates desired characteristics of individuals the user would like to meet. For example, in one embodiment, a system for providing user association in a computer environment is disclosed. The system includes a central server having a subscriber database, the subscriber database storing a plurality of subscriber data entries, each subscriber data entry including characteristics of a related subscriber. The system also includes a plurality of user association and communication devices. Each user association and communication device is associated with a user database that stores calling criteria data indicating preferred characteristics of subscribers. In use, the central server facilitates a calling connection between at least two user association and communication devices based on the calling criteria data stored in a user database and characteristics stored in the subscriber database. In one aspect, each user association and communication device includes a user database. However, as an alternative (or in addition to) the central server can include a plurality of user databases, with each user database being associated with a particular user association and communication device. In general, the central server facilitates the calling connection by selecting a subscriber having characteristics at least partially matching the calling criteria data stored in the user database associated with a requesting user communication and association device. Once connected, the calling connection can facilitate video and audio data transfer between user association and communication devices. As will be described in greater detail below, each user association and communication device can connected to a monitor having the ability to display video image data. In addition, a remote control device can be associated with each user association and communication device. Each remote control device can include a microphone capable of providing audio data to the associated user association and communication device.

In an additional embodiment, a user association and communication device is disclosed. The user association and communication device includes a processor and a video camera in communication with the processor. Also in communication with the processor is a video output module that is capable of providing video image data generated via the video camera to a monitor. Further, an audio output module is in communication with the processor, and is capable of providing audio data to an audio device, such as television speakers. A network adaptor also is in communication with the processor to facilitate a network connection. The user association and communication device is associated with a user database storing calling criteria data indicating preferred characteristics of subscribers, and can further include data comprising contact data for individuals subscribers, and contact data for emergency services. As above, the user database can be stored within the user association and communication device, or on a central server. In one aspect, the video output module can be connected to a monitor having the ability to display video image data during operation, allowing sending and receiving of video and audio data to and from another user association and communication device. Further, a remote control device can be associated with the user association and communication device. As above, the remote control device can include a microphone capable of providing audio data to the user association and communication device. In general, the user association and communication device is in communication with a central server having a subscriber database storing a plurality of subscriber data entries, each including characteristics of a related subscriber. In operation, the central server facilitates a calling connection between at least two user association and communication devices based on the calling criteria data stored in a user database and characteristics stored in the subscriber database.

In a further embodiment, a method for associating individuals via a network medium is disclosed. The method includes storing a plurality of subscriber data indicating characteristics of individual subscribers. In addition, a plurality of calling criteria data sets are stored that indicate preferred characteristics of subscribers. Each of the calling criteria data sets is associated with a requesting user. An individual subscriber is then selected having characteristics at least partially matching a calling criteria data set associated with the requesting user. Next, a calling connection is facilitated between the selected individual subscriber and the requesting user. As above, the calling criteria associated with the requesting user can be stored within a user database stored on a user association and communication device, or stored on a central server, the central server storing a plurality of user databases and the subscriber data. In this manner, embodiments of the present invention advantageously allow communication for individuals who are unfamiliar with or uncomfortable with technology using a visual method where a user does not need to remember or dial phone numbers or names. Thus, an easy and intuitive interface is provided allowing users with little or no experience with computers or computer interfaces to easily interface and utilize the embodiments of the present invention. Among other advantages, users are able to contact predefined individuals, find and contact new individuals not previously contacted, and find and contact groups having desired characteristics or interests. Moreover, emergency services are easily contacted through a visual contact means when a need arises. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration of a user association and communication device, in accordance with an embodiment of the present invention;

FIG. 2 is a schematic diagram showing an exemplary user association and communication device, in accordance with an embodiment of the present invention;

FIG. 3 is a flowchart showing a method for calling individuals or groups utilizing a user association and communication device, in accordance with an embodiment of the present invention;

FIG. 4 is a flowchart showing a call Friend method for contacting an individual previously stored on a user's friends list, in accordance with an embodiment of the present invention;

FIG. 5 is a diagram showing an exemplary Friend call type screen for selecting a friend to call, in accordance with an embodiment of the present invention;

FIG. 6 is an illustration showing a plurality of user association and communication devices connected to one another via a wide area network, such as the Internet.

FIG. 7 is an illustration showing a user communication and association device displaying streaming video during communication, in accordance with an embodiment of the present invention;

FIG. 8 is a flowchart showing a call family member method for contacting a family member previously stored on a user's family member list, in accordance with an embodiment of the present invention;

FIG. 9 is a diagram showing an exemplary family member call type screen for selecting a family member to call, in accordance with an embodiment of the present invention;

FIG. 10 is a flowchart showing a call someone new method for searching and connecting to individuals on the network having characteristics that match a user's predefined criteria but who are not currently on the user's friends or family lists, in accordance with an embodiment of the present invention;

FIG. 11 is a diagram illustrating an exemplary search request for a “someone new” operation, in accordance with an embodiment of the present invention;

FIG. 12A is a first portion of a flowchart showing a call group method for searching and connecting to groups on the network having characteristics that match a user's predefined criteria for groups, in accordance with an embodiment of the present invention;

FIG. 12B is a second portion of the flowchart showing a call group method for searching and connecting to groups on the network having characteristics that match a user's predefined criteria for groups, in accordance with an embodiment of the present invention;

FIG. 13 is a diagram illustrating an exemplary group search screen for performing a call group method, in accordance with an embodiment of the present invention;

FIG. 14 is a flowchart showing an emergency call method for contacting emergency services previously stored on a user's emergency list, in accordance with an embodiment of the present invention; and

FIG. 15 is a diagram showing an exemplary emergency service call type screen for selecting an emergency service to call, in accordance with an embodiment of the present invention.

### DETAILED DESCRIPTION OF THE PREFERRED EMBODIMENTS

An invention is disclosed for providing user association and communication in a wide area network environment via an easy-to-use, intuitive, networkable user association and communication device. Each user association and communication device is part of a network of such devices designed to communicate with one another via a wide area network such as the Internet. In general, embodiments of the present invention enable users to contact and communication with others utilizing a visual selection means. Among other advantages, users are able to contact predefined individuals, find and contact new individuals not previously contacted, and find and contact groups having desired characteristics or interests.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

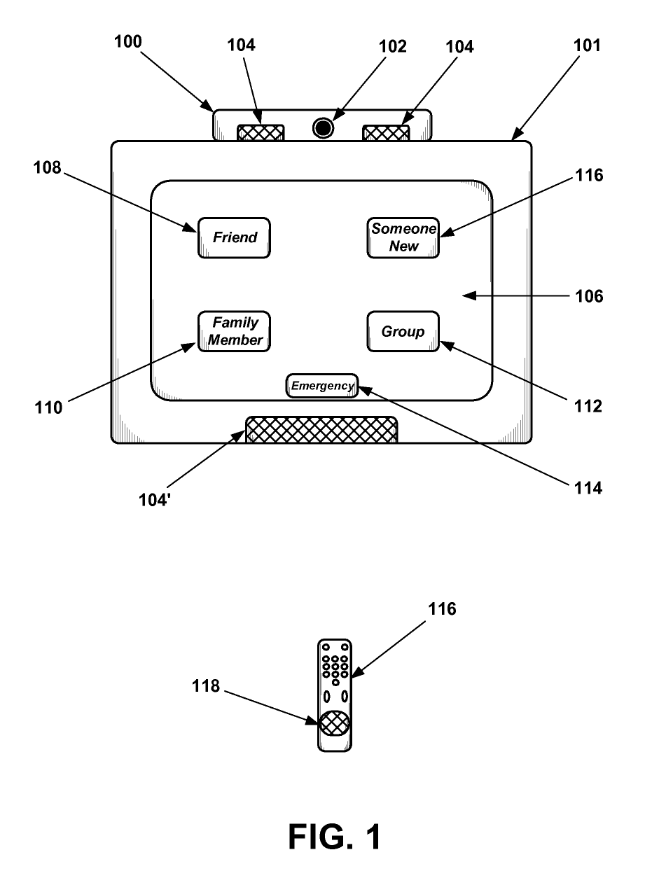

FIG. 1 is an illustration of a user association and communication device 100, in accordance with an embodiment of the present invention. In the illustrated embodiment, the user association and communication device 100 includes a camera 102 and speakers 104, both generally incorporated into a housing. The user association and communication device 100 generally is utilized in conjunction with a monitor 101, such as a television, that includes a screen 106 for displaying information to a user selection options. The monitor 101 can optionally include additional or substitute speakers 104′ for use with the user association and communication device 100. Additionally, a remote control 116 can be utilized with the system to provide users with remote access to the user association and communication device 100. In such case, the remote control 116 can include a microphone 118 for receiving voice/audio data from the user. Further components, such as network adapters, CPU(s), memory, and other components also are included and will be described in greater detail subsequently.

In one embodiment, the user association and communication device 100 can be utilized with a monitor 101 that is a television. In this embodiment, the user association and communication device 100 includes video and audio outputs that can be coupled to video and audio inputs of the television based monitor 101. For example, the video and audio outputs that can be coupled to video and audio inputs of the television based monitor 101 via a High Definition Multimedia Interface (HDMI) cable, RCA cables, a Coaxial cable or any other means that will be apparent to those skilled in the art with the hindsight provided by a careful reading of the present disclosure. In addition, as will be described in greater detail subsequently, the user association and communication device 100 generally is connected to a wide area network, such as the Internet, typically via a wired or wireless local network.

In operation, calling selection options are displayed on the screen 106 of the monitor 101 for user selection. As will be described in greater detail below, calling selections can include a friends list selection 108, a family member list selection 110, a group list selection 112, an emergency services list selection 114, and a someone new selection 116 for finding and connecting with someone new. Broadly speaking, once the user selects a calling selection, for example via the remote control 116, and optionally provides any additional information, the user association and communication device 100 displays the corresponding contact list and the user is allowed to select an individual or group from the list. The user association and communication device 100 then attempts to connect with the selected individual. Once a connection is established, the user can communicate with selected individual visually utilizing the camera 102 and microphone 118. While communicating, streaming video and audio of the user is sent to the user association and communication device 100 of the selected individual and vice versa. In this manner, embodiments of the present invention facilitate face-to-face communication between individuals around the world.

In addition to calling a known individual, the user can select to find and communicate with someone new using the someone new selection 116. In this case, the user association and communication device 100 searches for other individuals on the network having characteristics that match a user's predefined calling criteria. Once found, the selected individual is connected to the user as above.

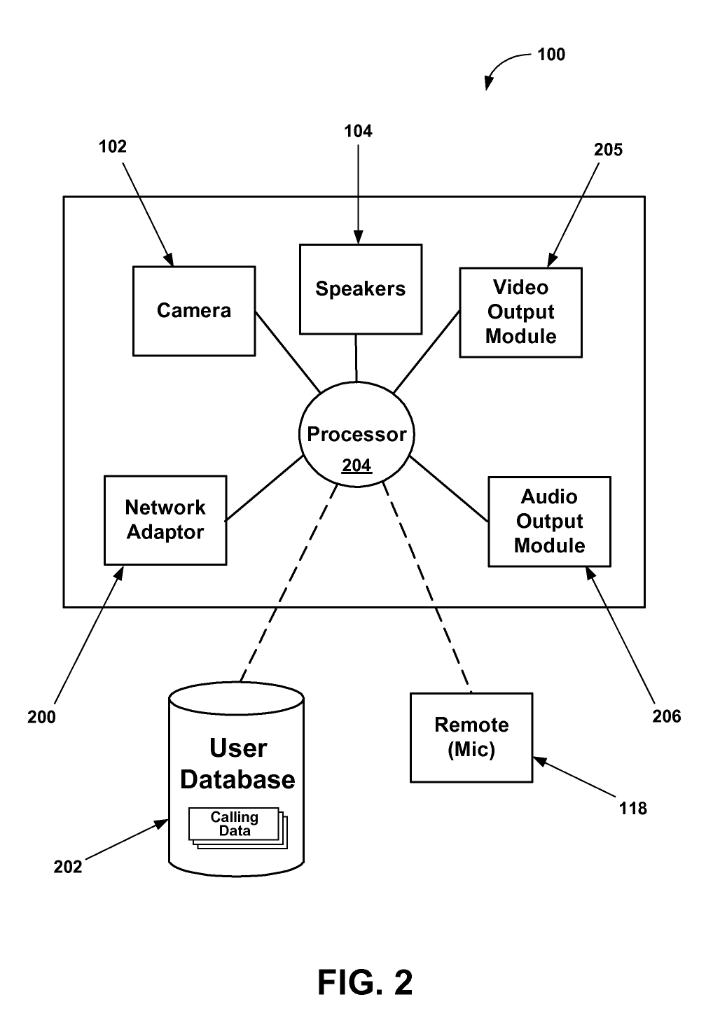

FIG. 2 is a schematic diagram showing an exemplary user association and communication device 100, in accordance with an embodiment of the present invention. As illustrated in FIG. 2, and described above, the exemplary user association and communication device 100 includes a camera 102, speakers 104, and video output module 205, an audio output module 206, and a network interface adaptor 200, all in communication with a processor 204. In addition, a user database 202 is associated with each user association and communication device 100. In one embodiment, the user database 202 is stored within the housing of the user association and communication device 100. However, in an additional embodiment, the user database 202 can be stored on a central server and associated with each particular user association and communication device 100. In either embodiment, each user association and communication device 100 is associated with a user database 202 for use with that particular user association and communication device 100. Moreover, as described above, a remote control generally is associated with the user association and communication device 100. The remote control generally includes a microphone 118 for use in sending voice/audio data to the user association and communication device 100.

As shown in FIG. 2, one embodiment of the present invention utilizes a video output module 205 and an audio output module 206 to provide video and audio data to a monitor, such as a television. In this embodiment, the user can utilize the remote control to make selections from selection options displayed on the screen of the monitor. In this manner, embodiments of the present invention provide an easy-to-use and intuitive interface for users who may be unfamiliar with or uncomfortable with normal computer use and displays. The screen and remote control allow a user to interact directly with displayed objects on the screen, where the objects are actually displayed, without the need of an intermediate device such as a keyboard. In this manner, an easy an intuitive interface is provided allowing users with little or no experience with computers or computer interfaces to easily interface and utilize the embodiments of the present invention.

In addition, an optional keyboard can be temporarily attached to facilitate initial setup of the user association and communication device 100. When initial setup, embodiments of the present invention allow the user to provide initial calling data. Initial calling data can include, for example, initial friends list data, initial family member list data, emergency services data, and initial group search criteria.

Initial friends list data generally includes data on one or more friends that are known at the time of initial setup. This data can include the friends name, an image of the friend, and their calling information such as network address, user ID information, or any other data that can be utilized by the user association and communication device 100 to contact the individual. Initial family member list data can include the same data as included in the friends list data. In addition, family member information can include phone numbers of particular family members for voice over Internet Protocal (VoIP) calling when the family member does not own a user association and communication device 100 of their own. Emergency services data can include phone numbers of particular emergency services, such as police, fire, and hospital, for voice over Internet Protocal (VoIP) calling, since emergency services may not have access to a user association and communication device 100 of their own. Finally, initial group search criteria can include characteristic data of group types the user may be interested in communicating with. The above data generally can be stored within the database 202, which is in communication with the processor 204 during initial setup.

In addition to data on known contacts, calling preference and calling criteria data can be stored for use when utilizing the user association and communication device 100 to find and connect to someone new, whose contact data is not currently stored within the database 202. As discussed above, a user can select to find and communicate with someone new using the someone new selection 116 of FIG. 1, wherein the user association and communication device 100 searches for other individuals on the network having characteristics that match the user's predefined criteria established during initial setup. The calling criteria data can include, for example, language preferences, gender preferences, hobbies, geographic preferences, or any other preference and/or criteria that can be designed or programmed into the system based on the needs and requests of system hosts and users/subscribers. These preferences and criteria can be, for exampled, entered into the user association and communication device 100 by a caregiver or other individual perhaps having more computer skill than the intended user. Although, it should be borne in mind that the data entry of the preference and criteria data can be entered by any means, including by the intended user. Moreover, it should be noted that such data may be entered via the screen 106 and remote control 116 instead of a separate keyboard if desired. Once the initial setup is complete, the user association and communication device 100 can be utilized to make calls based on the selections.

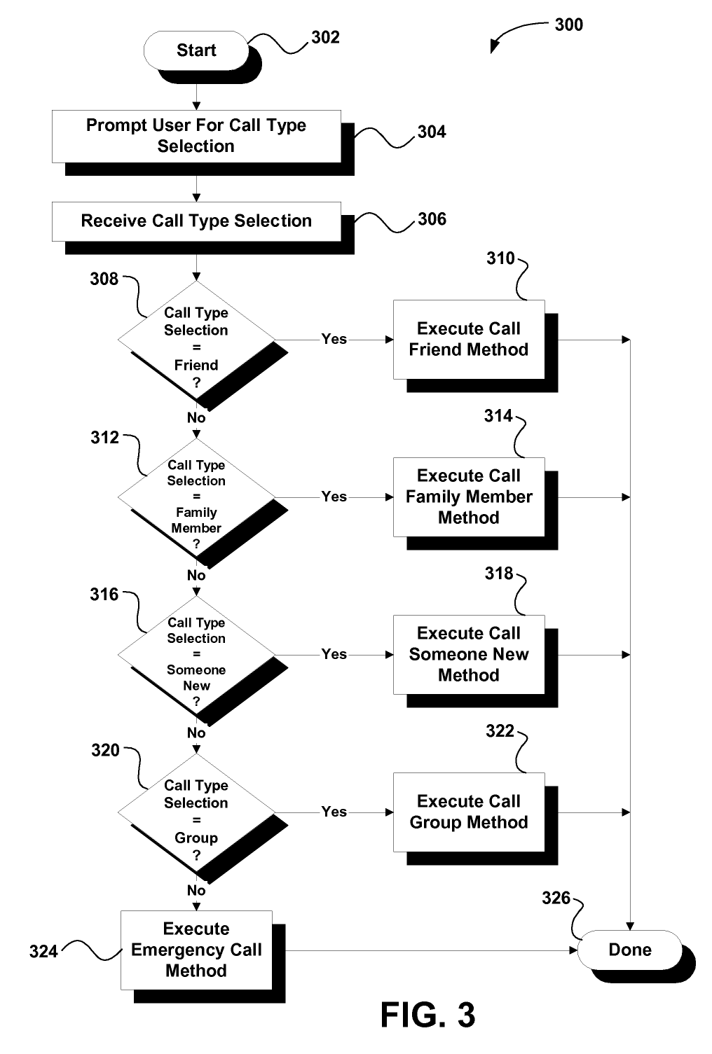

FIG. 3 is a flowchart showing a method 300 for calling individuals or groups utilizing a user association and communication device 100, in accordance with an embodiment of the present invention. In an initial operation 302, preprocess operations are completed. Preprocess operations can include, for example, entering initial setup data for individuals and groups, including network addresses, user ID data, or any other data that can be utilized by the user association and communication device 100 to contact individuals or groups. Preprocess operations can further include entering initial calling preference and calling criteria data, for example, language preferences, gender preferences, hobbies, geographic preferences, or any other preference that can be designed or programmed into the system based on the needs and requests of system hosts and users/subscribers. In addition, preprocess operations can include setting the user association and communication device to be either “available” or “unavailable.” An “available” setting indicates the user is available for incoming calls, while an “unavailable” setting indicates the user is not available for incoming calls and thus the system should not currently allow incoming calls.

In operation 304, the user is prompted for a call type selection, which indicates the type of call the user desires to perform. Once the user association and communication device 100 is setup as described previously, which for many devices generally occurs only once before the first use (although additional adjustments can be made at anytime), call selection type indicia is displayed on the screen of the monitor, as illustrated in FIG. 1. FIG. 1 shows a plurality of indicia displayed on the screen 106 of the monitor 101 for selection by the user. In this particular example, the indicia include a friends list selection 108, a family member list selection 110, a group list selection 112, an emergency services list selection 114, and a someone new selection 116 for finding and connecting with someone new. In this manner, a user can make call type selections in a very easy to understand and intuitive manner by using the remote control to select indicia on the screen 106.

Referring back to FIG. 3, the call type selection is received in operation 306. Once the user selects one of the call type indicia displayed on the screen, the corresponding call type selection is evaluated by the system. For example, turning to FIG. 1, when the user selects the indicia 108 labeled “Friend,” the call type selection is set to “Friend.”

A decision is then made, in operation 308, as to whether the call type selection is the “Friend” call type. If the call selection is the “Friend” call type, the method 300 branches to operation 310, where the call friend method 310 is performed and the method completes in operation 326. Otherwise, the method 300 continues to operation 312.

In operation 312, a decision is made as to whether the call type selection is the “Family Member” call type. If the call selection is the “Family Member” call type, the method 300 branches to operation 314, where the call Family Member method 314 is performed and the method completes in operation 326. Otherwise, the method 300 continues to operation 316.

In operation 316, a decision is made as to whether the call type selection is the “Someone New” call type. If the call selection is the “Someone New” call type, the method 300 branches to operation 318, where the call Someone New method 318 is performed and the method completes in operation 326. Otherwise, the method 300 continues to operation 320.

In operation 320, a decision is made as to whether the call type selection is the “Group” call type. If the call selection is the “Group” call type, the method 300 branches to operation 322, where the call Group method 322 is performed and the method completes in operation 326. Otherwise, the method 300 continues to operation 324, where the emergency call method 324.

Post process operations are then performed in operation 326. Post process operation can include, for example, prompting the user for a new call type selection, shutting down the system when requested to do so by the user, prompting the user to answer incoming call requests, and other post process operation that will be apparent to those skilled in the art after a careful reading of the present disclosure.

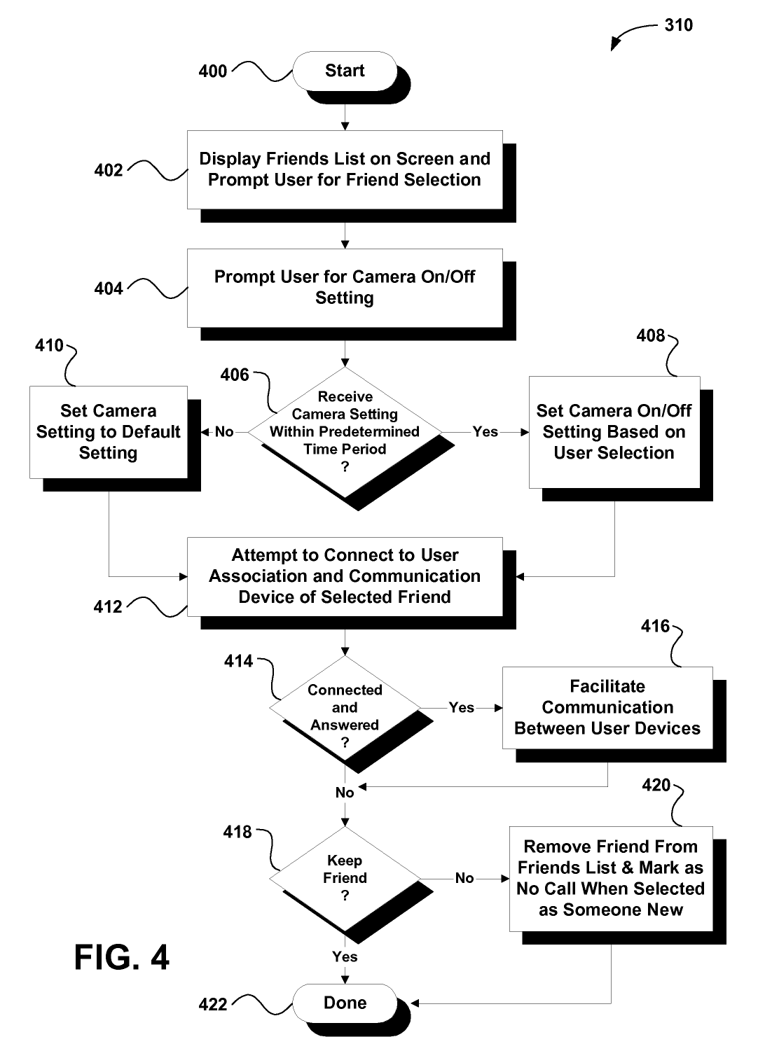

FIG. 4 is a flowchart showing a call Friend method 310 for contacting an individual previously stored on a user's friends list, in accordance with an embodiment of the present invention. In an initial operation 400, preprocess operations are performed. Preprocess operation can include, for example, prompting a user for a call type selection, receiving a “Friend” call type selection, and other preprocess operation that will be apparent to those skilled in the art after a careful reading of the present disclosure.

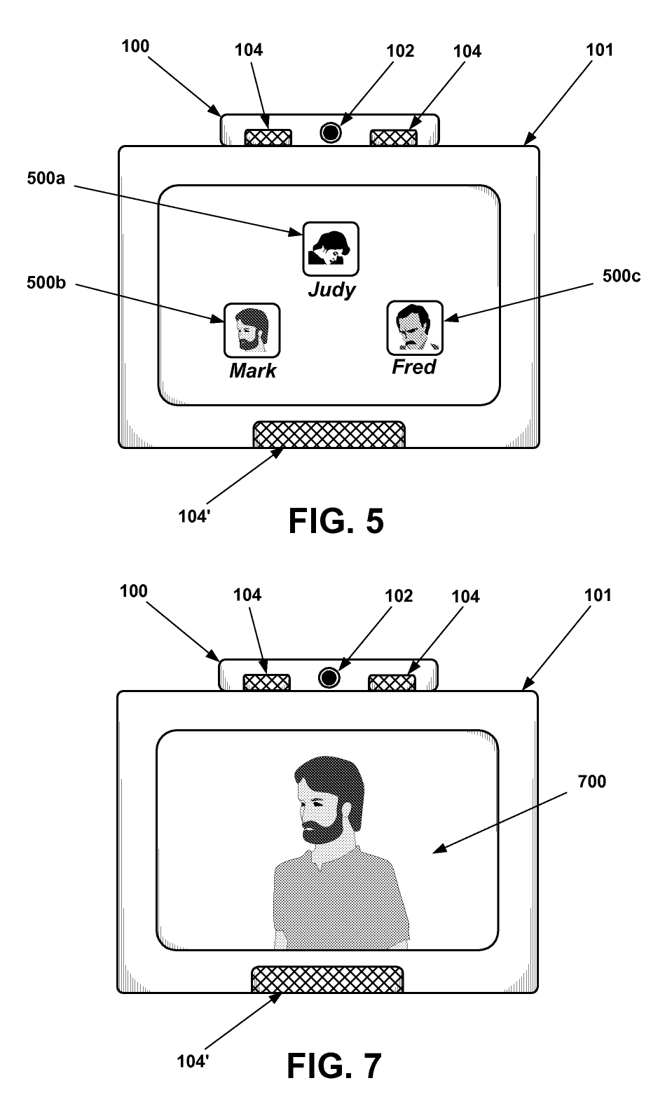

In operation 402, the user is prompted for a friend selection and the friend selection data is received from the user. As described above, generally a user database 202 is associated with the user association and communication device 100 that stores, among other data, a Friends list that generally includes data associated with one or more friends. This information can include each individual's name, an image of the individual, and their calling information such as network address, user ID data, or any other data that can be utilized by the user association and communication device 100 to contact the individual. The Friends list is utilized by the user association and communication device 100 to display a plurality of friend selection indicia on the screen of a monitor for selection by the user, as illustrated in FIG. 5.

FIG. 5 is a diagram showing an exemplary Friend call type screen for selecting a friend to call, in accordance with an embodiment of the present invention. When displaying the Friend call type screen, the user association and communication device 100 uses the monitor 101 to display a plurality of friend selection indicia 500a-500c. Each friend selection indicia 500a-500c is selectable by the user to indicate which individual they want to call. As illustrated in the example of FIG. 5, each friend selection indicial 500a-500c can comprise an image of the corresponding individual and the name of the individual, which can be displayed below or otherwise near the image of the individual. In addition, in some embodiments, the image of the each individual can indicate whether the user is currently “available” or “unavailable,” for example, color images can indicate “available” individuals while black and white images can indicate “unavailable” individuals. The user can then select an individual to call by selecting the image of the friend using the remote control. Once the user selects an individual to call, the user association and communication device 100 sets the friend selection to the selected friend.

Referring back to FIG. 4, the user is prompted to set the camera 102 to ON or OFF, in operation 404. As described previously, the user association and communication device 100 includes a camera 102 which is utilized to send streaming video while communicating with other individuals on the same system. However, there may be times when a user does not wish to allow them self to be seen. At these times the user can set the camera 102 to OFF, thus blocking images and video of them to be sent during communication.

A decision is then made as to whether the camera setting has been received within a predetermined time, in operation 406. For example, the device may wait 15 seconds to receive the user's camera setting selection from operation 404. If the device has received the user's camera setting selection within the predetermined time, the method 310 branches to operation 408 where the camera is set to either ON or OFF based on the user's camera setting selection. Otherwise, the method 310 continues to operation 410 where the camera is set to a default setting. In general, the default setting can be ON, however the default setting can be set to either ON or OFF based on the needs and desires of each particular user. In one embodiment, when the camera is set to OFF a static image of the user can be displayed on the screens of other users during communication.

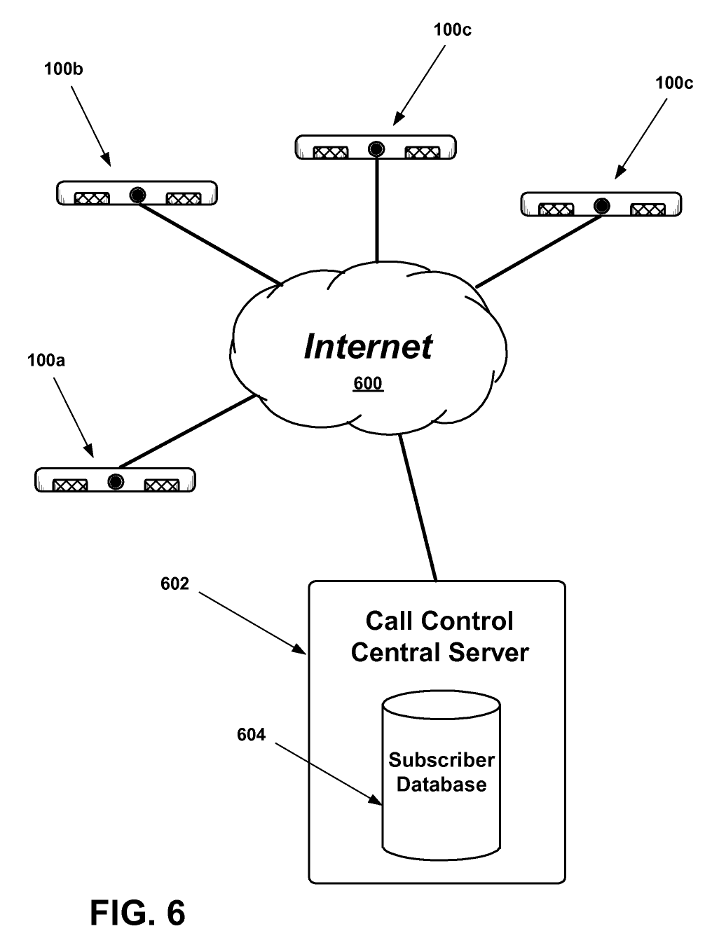

In operation 412, an attempt is made to connect to the user association and communication device of the selected friend. As mentioned above, embodiments of the present invention are connected to other similar devices via a wide area network such as the Internet. FIG. 6 is an illustration showing a plurality of user association and communication devices 100a-100d connected to one another via a wide area network, such as the Internet 600. In addition, FIG. 6 shows a call control central server 602 also in communication with the Internet 600. The call control central server 602 includes a subscriber database 604 that stores subscriber information, such as user data for each user of the system, call logs for all calls made utilizing the system, and other information useful to the system as will be apparent to those skilled in the art with the hindsight received from a careful reading of the present disclosure. Optionally, the call control central server 602 can include a plurality user databases, each associated to a particular user association and communication device.

In operation, the system uses the individual user association and communication devices 100a-100d and the call control central server 602 to afford communication between individuals and groups via the Internet 600. For example, user association and communication device 100a may attempt to contact user association and communication device 100b. Here, connection information for contacting the user of user association and communication device 100b may be stored on the user database associated with user association and communication device 100a. Additional calling and contact information for user association and communication device 100b may be stored on the subscriber database 604 of the call control central server 602 depending on the particular design of an embodiment. In general, when a call is initiated, information regarding the call is sent from the initiating user association and communication device 100a to the call control central server 602, which logs the call in the subscriber database 604 and may perform additional operations to facilitate the call. The recipient user association and communication device 100b is then contacted via the Internet 600 using the calling data stored on user database associated with the initiating user association and communication device 100a and the optionally the subscriber database 604.

Referring back to FIG. 4, a decision is then made as to whether a connection has been established with the selected friend, in operation 414. Turning to FIG. 6, the recipient user association and communication device 100b rings or otherwise notifies the recipient user that another user is attempting to contact them. Referring back to FIG. 4, if the recipient user is either not available and does not answer, the method 310 continues to operation 418. However, if the recipient user is both available and answers the call, the method 310 branches to operation 416, where communication is allowed.

Specifically, in operation 416, the users are connected to one another via the two user association and communication device 100a and 100b as illustrated in FIG. 7. FIG. 7 is an illustration showing a user communication and association device 100 displaying streaming video 700 during communication, in accordance with an embodiment of the present invention. As described previously, once the user selects a friend to call, the user association and communication device 100 attempts to connect with the selected individual. Once a connection is established, the user can communicate with selected individual visually utilizing the camera 102 and microphone 118 of the remote control. While communicating, streaming video 700 and audio of the user is sent to the user association and communication device 100 of the selected individual and vice versa. In this manner, embodiments of the present invention facilitate face-to-face communication between individuals around the world.

Turning back to FIG. 4, when the communication is completed a decision is made as to whether the selected friend should remain on the friends list, in operation 418. In general, at this point embodiments of the present invention prompt the user to select whether or not the selected friend should remain on the friends list. Based on the user's selection the system determines whether or not to remove the friend from the friends list. Specifically, if the user selects to remove the friend from the friends list, the method 310 branches to operation 420, where the friend data for the selected friend is removed from the friends list. In addition, in operation 420, the friend data is marked such that the friend is not chosen when the system attempts find someone new, as will be described in greater detail subsequently. If the user selects to keep the friend on the friends list, the method 310 completes in operation 422, where post process operations are performed. Post process operation can include, for example, prompting the user for a new call type selection, shutting down the system when requested to do so by the user, prompting the user to answer incoming call requests, and other post process operation that will be apparent to those skilled in the art after a careful reading of the present disclosure.

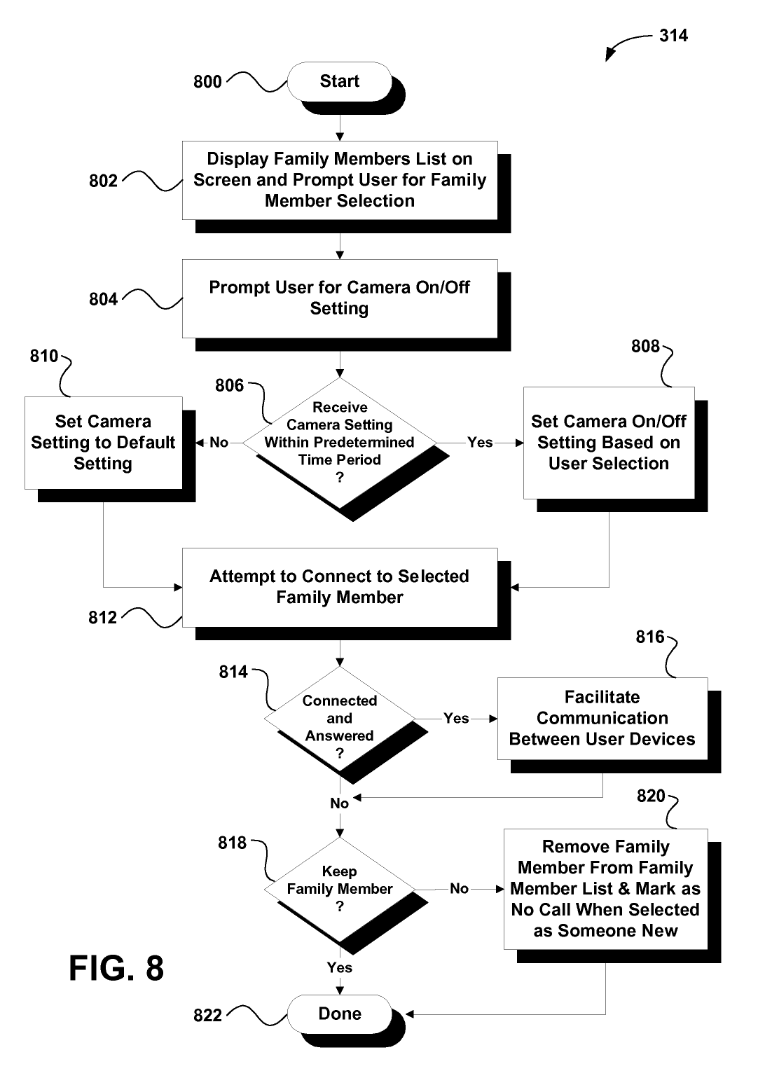

FIG. 8 is a flowchart showing a call family member method 314 for contacting a family member previously stored on a user's family member list, in accordance with an embodiment of the present invention. In an initial operation 800, preprocess operations are performed. Preprocess operation can include, for example, prompting a user for a call type selection, receiving a “family member” call type selection, and other preprocess operation that will be apparent to those skilled in the art after a careful reading of the present disclosure.

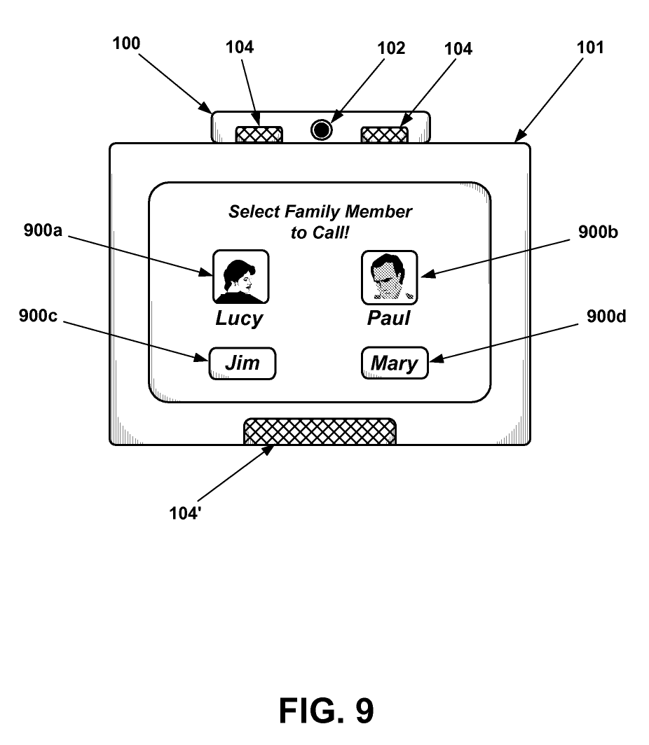

In operation 802, the user is prompted for a family member selection and the family member selection data is received from the user. As described above, generally a database 202 is associated with the user association and communication device 100 that stores, among other data, a family member list that generally includes data previous stored within the database 202 associated with one or more family members. This information can include each family member's name, an image of the family member, and their calling information such as network address, user ID data, or any other data that can be utilized by the user association and communication device 100 to contact the family member. The family member list is utilized by the user association and communication device 100 to display a plurality of family member selection indicia on the monitor 101 for selection by the user, as illustrated in FIG. 9.

FIG. 9 is a diagram showing an exemplary family member call type screen for selecting a family member to call, in accordance with an embodiment of the present invention. When displaying the family member call type screen, user association and communication device uses the monitor 101 to display a plurality of family member selection indicia 900a-900d. Each family member selection indicia 900a-900d is selectable by the user to indicate which family member they want to call. Each family member selection indicial 900a-900d can comprise an image of the corresponding family member and the name of the family member, which can be displayed below or otherwise near the image of the family member. In addition, in some embodiments, the image of the each family member can indicate whether the user is currently “available” or “unavailable,” for example, color images can indicate “available” family members while black and white images can indicate “unavailable” family members. The user can then use the remote control to select a family member to call by selecting the image of the family member. Once the user selects a family member to call, the user association and communication device 100 sets the family member selection to the selected family member.

Referring back to FIG. 8, the user is prompted to set the camera 102 to ON or OFF, in operation 804. A decision is then made as to whether the camera setting has been received within a predetermined time, in operation 806. If the device has received the user's camera setting selection within the predetermined time, the method 314 branches to operation 808 where the camera is set to either ON or OFF based on the user's camera setting selection. Otherwise, the method 314 continues to operation 810 where the camera is set to a default setting. In general, the default setting can be ON, however the default setting can be set to either ON or OFF based on the needs and desires of each particular user. In one embodiment, when the camera is set to OFF a static image of the user can be displayed on the screens of other users during communication.

In operation 812, an attempt is made to connect to the user association and communication device of the selected family member. As mentioned above, embodiments of the present invention are connected to other similar devices via a wide area network such as the Internet. In addition, when calling family members, embodiments of the present invention allow communication with family members using conventional telephone communication utilizing VoIP. For example, the family member information can include phone numbers of particular family members for VoIP calling when the family member does not own a user association and communication device 100 of their own.

A decision is then made as to whether a connection has been established with the selected family member, in operation 814. If the recipient user is either not available or does not answer, the method 314 continues to operation 818. However, if the family member is both available and answers the call, the method 314 branches to operation 816, where communication is allowed.

Specifically, in operation 816, the users are connected to one another via the two user association and communication device 100a and 100b. Once a connection is established, the user can communicate with selected individual visually utilizing the camera and microphone of the user association and communication device and remote control. While communicating, streaming video and audio of the user are sent to the user association and communication device of the selected family member and vice versa. However, when the selected family member does not own a user association and communication device, communication can be established via VoIP, wherein the selected family communicates utilizing a conventional telephone and the caller communicates using the user association and communication device. In this case, a static image of the family member can be displayed during communication.

In operation 818, a decision is made as to whether the selected family member should remain on the family member list. At this point embodiments of the present invention prompt the user to select whether or not the selected family member should remain on the family member list. If the user selects to remove the family member from the family member list, the method 314 branches to operation 820, where the family member data for the selected family member is removed from the friends list. In addition, in operation 820, the family member data is marked such that the family member is not chosen when the system attempts find someone new, as will be described in greater detail subsequently. If the user selects to keep the family member on the family member list, the method 314 completes in operation 822, where post process operations are performed. As described previously, post process operation can include, for example, prompting the user for a new call type selection, shutting down the system when requested to do so by the user, prompting the user to answer incoming call requests, and other post process operation that will be apparent to those skilled in the art after a careful reading of the present disclosure.

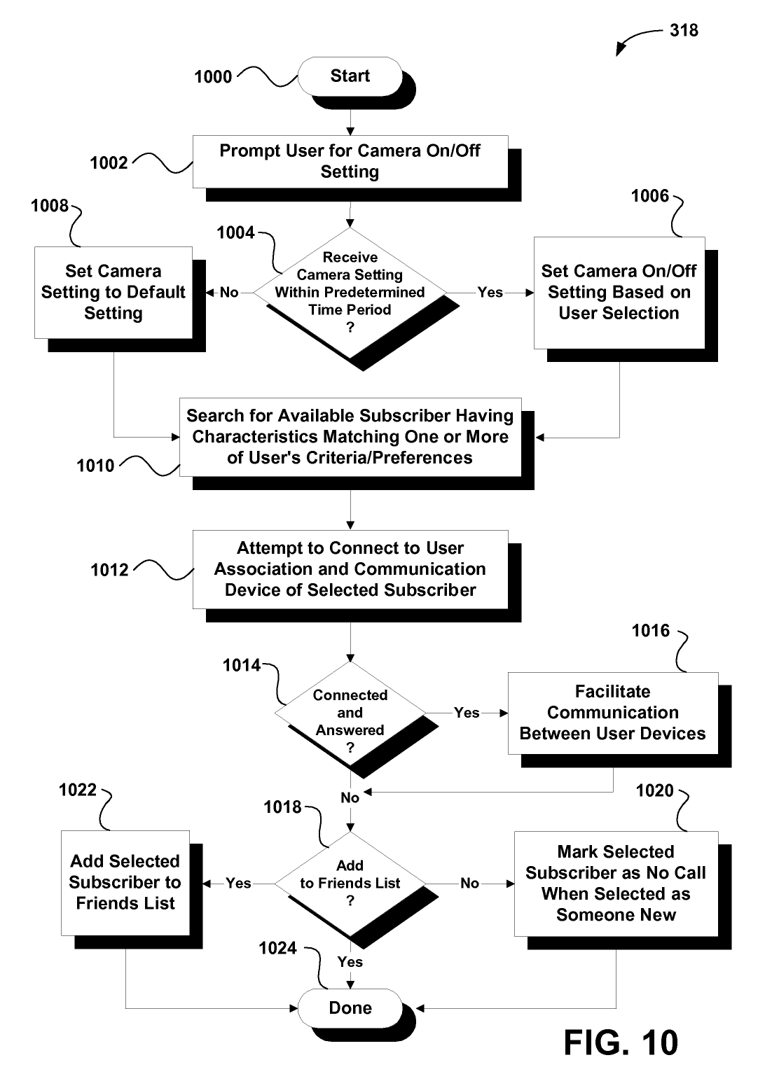

FIG. 10 is a flowchart showing a call someone new method 318 for searching and connecting to individuals on the network having characteristics that match a user's predefined criteria but who are not currently on the user's friends or family lists, in accordance with an embodiment of the present invention. In an initial operation 1000, preprocess operations are performed. Preprocess operation can include, for example, prompting a user for a call type selection, receiving a “someone new” call type selection, and other preprocess operation that will be apparent to those skilled in the art after a careful reading of the present disclosure.

In operation 1002, the user is prompted to set the camera to ON or OFF. A decision is then made as to whether the camera setting has been received within a predetermined time, in operation 1004. If the device has received the user's camera setting selection within the predetermined time, the method 318 branches to operation 1006 where the camera is set to either ON or OFF based on the user's camera setting selection. Otherwise, the method 318 continues to operation 1008 where the camera is set to a default setting. In general, the default setting can be ON, however the default setting can be set to either ON or OFF based on the needs and desires of each particular user. In one embodiment, when the camera is set to OFF a static image of the user can be displayed on the screens of other users during communication.

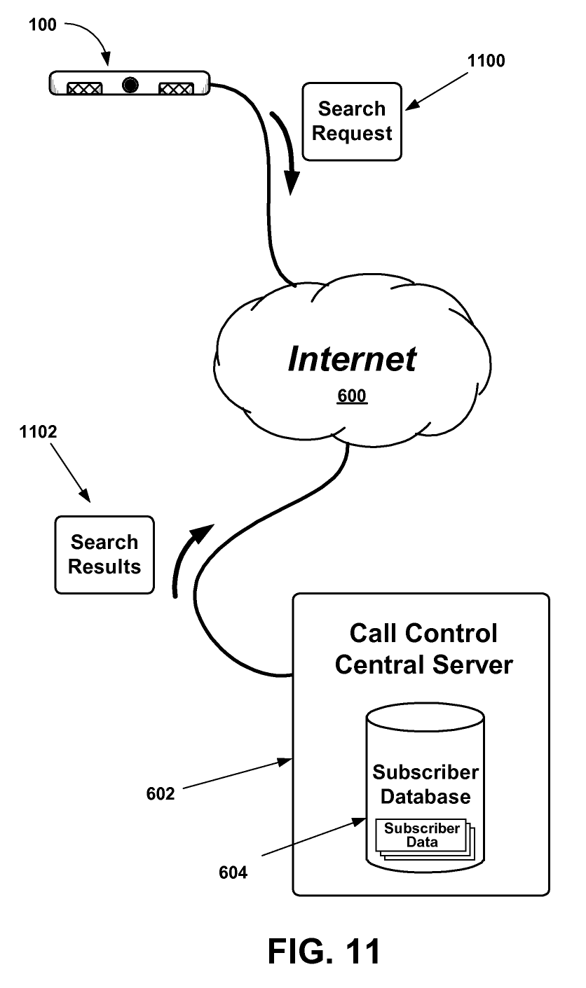

In operation 1010, the system performs a search for available subscribers currently online that have characteristics substantially matching one or more of the user's predefined criteria and/or preferences. As described previously, calling preference and calling criteria data is stored in a user database 202 associated with the user association and communication device 100 for use when attempting to find and connect to someone new, whose contact data is not currently stored within the associated user database 202. The calling criteria data can include, for example, language preferences, gender preferences, hobbies, geographic preferences, or any other preference and/or criteria that can be designed or programmed into the system based on the needs and requests of system hosts and users/subscribers. During operation 1010 a search request is sent to the call control central server to find an appropriate individual based on the calling criteria data associated with the user, as illustrated in FIG. 11.

FIG. 11 is a diagram illustrating an exemplary search request for a “someone new” operation, in accordance with an embodiment of the present invention. As shown in FIG. 11, a user association and communication device 100 is connected to the call control central server 602 via a wide area network, such as the Internet 600. In one embodiment, the user association and communication device 100 sends a search request 1100 to the call control central server 602 via the Internet 600. In one embodiment, the search request includes, inter alia, the user calling criteria and preference data stored on the user database 202. However, as mentioned previously, the user database associated with the user association and communication device 100 can be stored on the call control central server 602. In this embodiment, the search request can reference the associated user database 202 stored on the call control central server for use in performing the requested search. Once received, the search request 1100 is examined and parsed by the call control central server 602 to perform the requested search. In one embodiment, the call control central server 602 performs the requested search by searching the subscriber database 604 for subscribers having characteristics matching one or more of the calling criteria and preference data associate with the received search request 1100.

Once found, the subscribers can be ranked based on the number of characteristics matching the calling criteria and preferences, and data regarding the highest ranked subscribers can be sent back to the requesting user association and communication device 100 as search results 1102. Once the requesting user association and communication device 100 receives the search results 1102, the user association and communication device 100 can examine the search results and remove any subscriber data for subscribers previously marked as “do not call,” as mentioned above, and further subscriber data matching current “friends” or “family members” can be removed. However, it should be borne in mind that such subscriber data can be removed at the call control central server 602 prior to sending the search results 1102, depending on the needs and processing load requirements designed into a particular embodiment.

Turning back to FIG. 10, an attempt is made to connect to the user association and communication device of the selected subscriber, in operation 1012. As mentioned above, embodiments of the present invention are connected to other similar devices via a wide area network such as the Internet. In general, connection information for contacting the selected subscriber is stored in the search results returned from the call control central server. When a call is initiated, information regarding the call is sent from the initiating user association and communication device to the call control central server, which logs the call in the subscriber database and may perform additional operations to facilitate the call. The recipient user association and communication device then is contacted via the Internet using the calling data stored in the search results and optionally the subscriber database on the call control central server.

A decision is then made as to whether a connection has been established with the selected subscriber, in operation 1014. If the selected subscriber is either not available or does not answer, the method 318 completes in operation 1024. However, if the selected subscriber is both available and answers the call, the method 318 branches to operation 1016, where communication is facilitated.

Specifically, in operation 1016, the user and selected subscriber are connected to one another via the two user association and communication devices. Once a connection is established, the user can communicate with selected subscriber visually utilizing the camera of the user association and communication device and microphone on the remote control. While communicating, streaming video and audio of the user are sent to the user association and communication device of the selected family member and vice versa. In this manner, embodiments of the present invention facilitate face-to-face communication between individuals around the world.

In operation 1018, a decision is made as to whether the selected subscriber should be added to the user's friends list. At this point embodiments of the present invention prompt the user to select whether or not the selected subscriber should be added to the friends list. If the user selects not to add the selected subscriber to the friends list, the method 318 branches to operation 1020, where the selected subscriber is marked as “do not call” such that the selected subscriber is not chosen when the system attempts another “someone new” method 318. If the user selects to add the selected subscriber to the user's friends list, the method 318 continues to operation 1022, where user data for the selected subscriber is added to the user's friends list.

The method 318 completes in operation 1024, where post process operations are performed. As described previously, post process operation can include, for example, prompting the user for a new call type selection, shutting down the system when requested to do so by the user, prompting the user to answer incoming call requests, and other post process operation that will be apparent to those skilled in the art after a careful reading of the present disclosure.

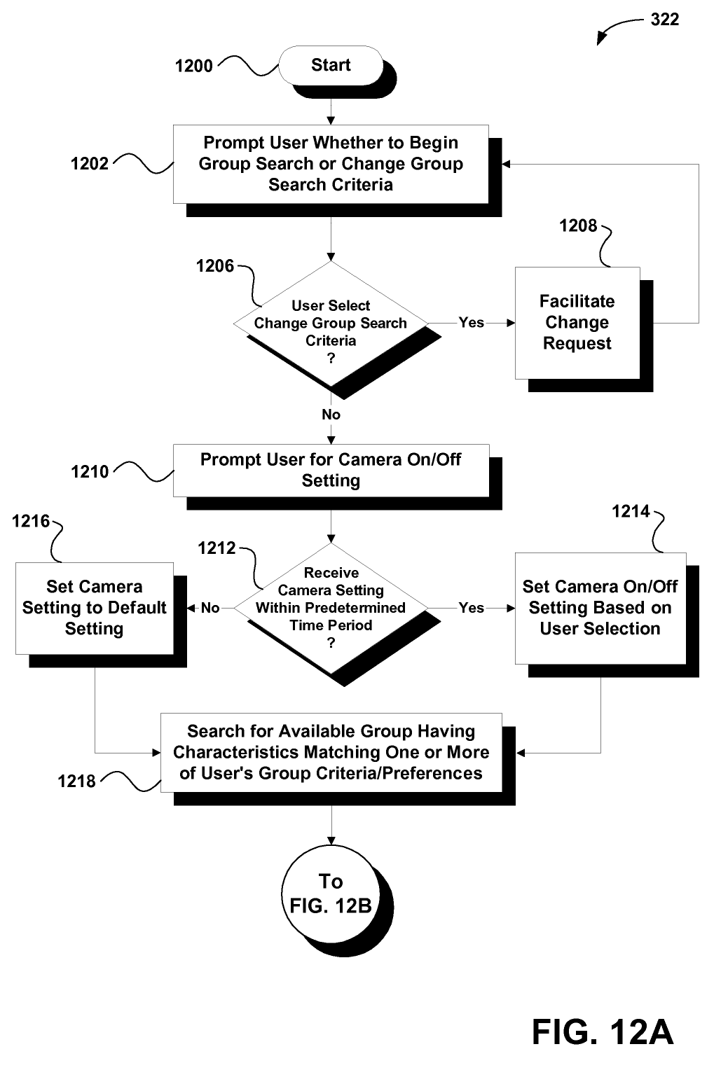

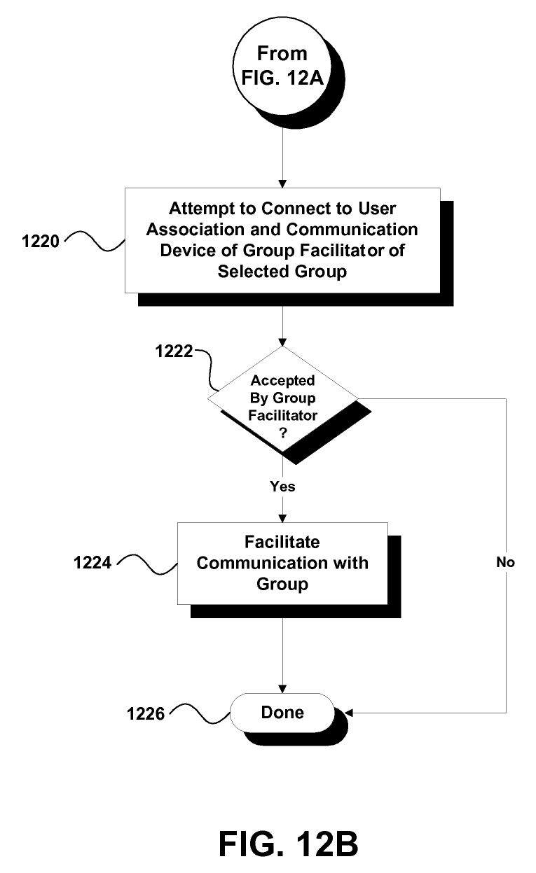

FIG. 12A and 12B form a flowchart showing a call group method 322 for searching and connecting to groups on the network having characteristics that match a user's predefined criteria for groups, in accordance with an embodiment of the present invention. In an initial operation 1200, preprocess operations are performed. Preprocess operation can include, for example, prompting a user for a call type selection, receiving a “group” call type selection, and other preprocess operation that will be apparent to those skilled in the art after a careful reading of the present disclosure.

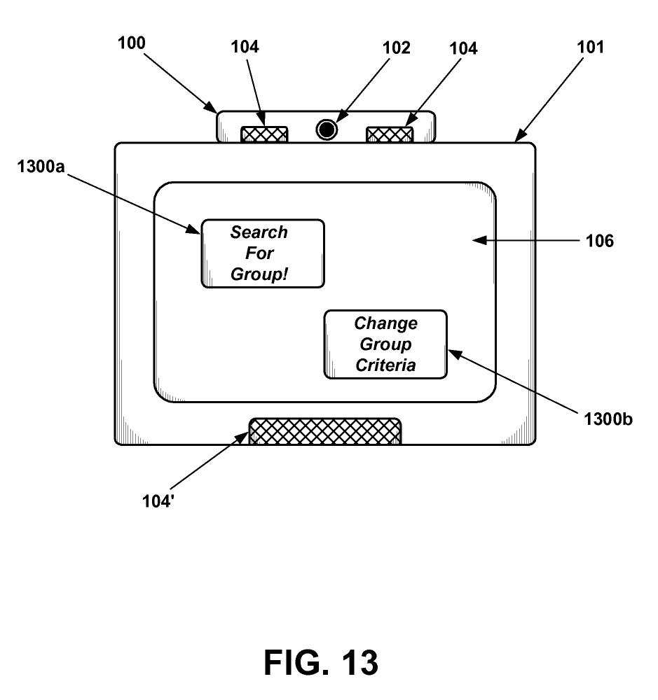

In operation 1202, the user is prompted to either search for a group to call using current group search criteria or to change the group search criteria. FIG. 13 is a diagram illustrating an exemplary group search screen for performing a call group method, in accordance with an embodiment of the present invention. When performing a call group method, the user association and communication device 100 displays group calling indicia 1300a-1300b selectable by the user to determine whether a search should be immediately performed or additional search criteria should be gathered. More specifically, a group call indicia 1300a is displayed that allows the user to search for a group to call using current group search criteria previously stored in the device 100, such as during initial setup. In addition, a group call indicia 1300b is displayed that allows the user to change the group search criteria prior to conducting a search for a new group.

A decision is then made, in operation 1206, as to whether the user selected the change group search criteria indicia 1300b. If the user selected the change group search criteria indicia 1300b, the method 322 branches to operation 1208, where the user is allowed to change the group search criteria. Otherwise, the method 322 continues to operation 1210, where the user is prompted for a camera ON/OFF setting.

In operation 1208, the user is allowed to change the group search criteria. Group search criteria can include, for example, language preferences, gender preferences, hobbies, geographic preferences, hobbies, or any other preference and/or criteria that can be designed or programmed into the system based on the needs and requests of system hosts and users/subscribers. In one embodiment, the user association and communication device facilitates this action by allowing the user to select various predefined criteria utilizing the remote control, allowing the user to interact directly with displayed criteria objects on the screen, where they are actually displayed, without the need of keyboard.

Referring back to FIG. 12A, the user is prompted to set the camera 102 to ON or OFF, in operation 1210. A decision is then made as to whether the camera setting has been received within a predetermined time, in operation 1212. If the device has received the user's camera setting selection within the predetermined time, the method 322 branches to operation 1214 where the camera is set to either ON or OFF based on the user's camera setting selection. Otherwise, the method 322 continues to operation 1216 where the camera is set to a default setting. In general, the default setting can be ON, however the default setting can be set to either ON or OFF based on the needs and desires of each particular user. In one embodiment, when the camera is set to OFF a static image of the user can be displayed on the screens of other users during communication.

In operation 1218, the system performs a search for available subscriber groups currently online having characteristics substantially matching one or more of the user's predefined group search criteria and/or preferences. As described previously, group search criteria data is stored in a database 202 for use when utilizing the user association and communication device 100 to find and connect to an online group. The group search criteria can include, for example, language preferences, gender preferences, hobbies, geographic preferences, or any other preference and/or criteria that can be designed or programmed into the system based on the needs and requests of system hosts and users/subscribers. During operation 1218 the group search criteria data is utilized to send a search request to the call control central server to find an appropriate online group.

Once an appropriate group is found and selected, an attempt is made to connect to the user association and communication device of a member of the selected online group, in operation 1220 of FIG. 12B. As mentioned above, embodiments of the present invention are connected to other similar devices via a wide area network such as the Internet. In general, connection information for contacting the selected subscriber group is stored in the search results returned from the call control central server. When a call is initiated, information regarding the call is sent from the initiating user association and communication device to the call control central server, which logs the call in the subscriber database and may perform additional operations to facilitate the call. A recipient user association and communication device of the group then is contacted via the Internet using the calling data stored in the search results and optionally the subscriber database on the call control central server.

A decision is then made as to whether a connection has been established with a member of the selected group, in operation 1222. In one embodiment, groups are facilitated by a group facilitator who is a member of the current online group. When initially contacted, the group facilitator can be shown a static image of the user, and optionally additional biographical/characteristic information. The group facilitator can then decide to either accept the user into the group or refuse the user's request. Optionally, the user's image can be shown to all members of the current online group and the group can be allowed to vote on whether to accept the user into the group. If the user is accepted into the group, a connection is established and the method 322 continues with operation 1224, where the user is allowed to communicate with the group. Otherwise, the method 322 completes in operation 1226, where post process operations are performed. As described previously, post process operation can include, for example, prompting the user for a new call type selection, shutting down the system when requested to do so by the user, prompting the user to answer incoming call requests, and other post process operation that will be apparent to those skilled in the art after a careful reading of the present disclosure.

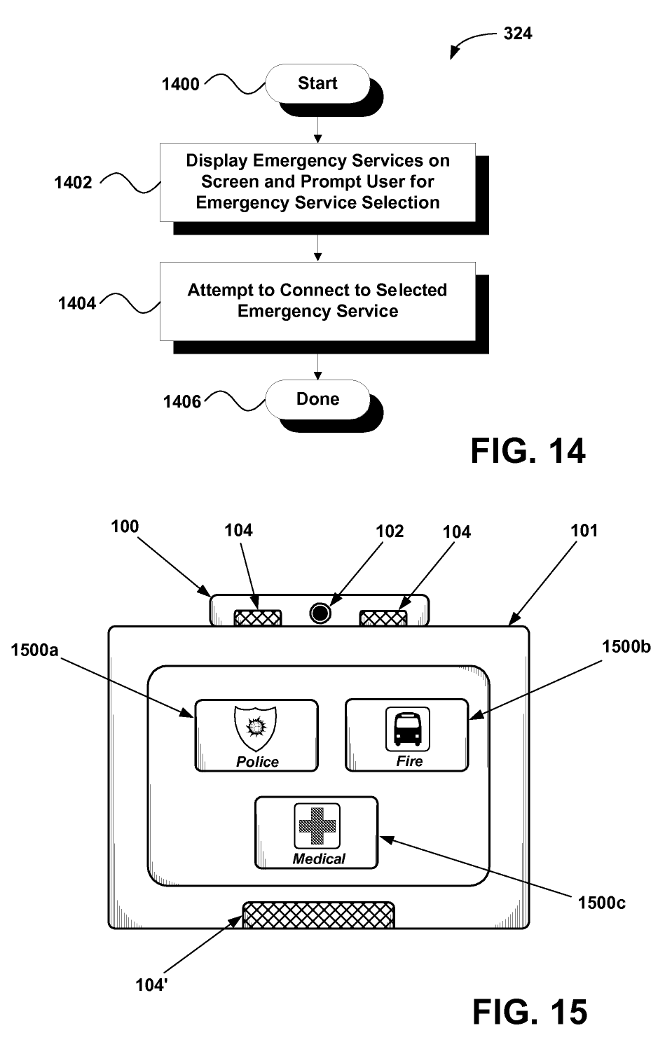

FIG. 14 is a flowchart showing an emergency call method 324 for contacting emergency services previously stored on a user's emergency list, in accordance with an embodiment of the present invention. In an initial operation 1400, preprocess operations are performed. Preprocess operation can include, for example, prompting a user for a call type selection, receiving a “emergency” call type selection, and other preprocess operation that will be apparent to those skilled in the art after a careful reading of the present disclosure.

In operation 1402, the user is prompted for an emergency service selection and the emergency service selection data is received from the user. As described above, generally a database 202 is associated with the user association and communication device 100 that stores, among other data, an emergency service list that generally includes data previous stored within the database 202 associated with one or more emergency services. This information can include each emergency service name and their calling information, such as telephone number. The emergency service list is utilized by the user association and communication device 100 to display a plurality of emergency service selection indicia on the monitor 101 for selection by the user, as illustrated in FIG. 15.

FIG. 15 is a diagram showing an exemplary emergency service call type screen for selecting an emergency service to call, in accordance with an embodiment of the present invention. When displaying the emergency service call type screen, the user association and communication device 100 utilizes the monitor 101 to display a plurality of emergency service selection indicia 1500a-1500c. Each emergency service selection indicia 1500a-1500c is selectable by the user to indicate which emergency service they want to call. Each emergency service selection indicial 1500a-1500c can comprise an image of the corresponding emergency service and the name of the emergency service, which can be displayed below or otherwise near the image of the individual. The user can then select an emergency service to call utilizing the remote control. Once the user selects an emergency service to call, the user association and communication device 100 sets the emergency service selection to the selected emergency service.

In operation 1404, an attempt is made to connect to the selected emergency service. When calling emergency services embodiments of the present invention allow communication with emergency services using conventional telephone communication utilizing VoIP. For example, the emergency service information can include phone numbers of particular emergency services for VoIP calling. Once connected, the user association and communication device facilitates the call to the emergency service.

The method 324 completes in operation 1406, where post process operations are performed. As described previously, post process operation can include, for example, prompting the user for a new call type selection, shutting down the system when requested to do so by the user, prompting the user to answer incoming call requests, and other post process operation that will be apparent to those skilled in the art after a careful reading of the present disclosure.

In this manner, embodiments of the present invention advantageously allow communication for individuals who are unfamiliar with or uncomfortable with technology using a visual method where a user does not need to remember or dial phone numbers or names. Thus, an easy and intuitive interface is provided allowing users with little or no experience with computers or computer interfaces to easily interface and utilize the embodiments of the present invention. Among other advantages, users are able to contact predefined individuals, find and contact new individuals not previously contacted, and find and contact groups having desired characteristics or interests. Moreover, emergency services are easily contacted through a visual contact means when a need arises.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for providing user association in a computer environment, comprising the operations of:
a central server having a subscriber database, the subscriber database storing a plurality of subscriber data entries, each subscriber data entry including characteristics of a related subscriber; and
a plurality of user association and communication devices, each user association and communication device being associated with a user database, each user database storing calling criteria data indicating preferred characteristics of subscribers,
wherein the central server facilitates a calling connection between at least two user association and communication devices based on the calling criteria data stored in a user database and characteristics stored in the subscriber database.

2. A system as recited in claim 1, wherein each user association and communication device includes a user database.

3. A system as recited in claim 1, wherein the central server includes a plurality of user databases, each user database being associated with a particular user association and communication device.

4. A system as recited in claim 1, wherein the central server facilitates the calling connection by selecting a subscriber having characteristics at least partially matching the calling criteria data stored in the user database associated with a requesting user communication and association device.

5. A system as recited in claim 1, wherein the calling connection facilitates video and audio data transfer between user association and communication devices.

6. A system as recited in claim 1, wherein each user association and communication device is connected to a monitor having the ability to display video image data.

7. A system as recited in claim 1, further comprising a remote control device associated with each user association and communication device, each remote control device including a microphone capable of providing audio data to the associated user association and communication device.

8. A user association and communication device, comprising:
a processor;
a video camera in communication with the processor;
a video output module in communication with the processor, the video output module capable of providing video image data generated via the video camera to a monitor;
an audio output module in communication with the processor, the audio output module capable of providing audio data to an audio device; and
a network adaptor in communication with the processor, the network adaptor capable of facilitating a network connection,
wherein the user association and communication device is associated with a user database storing calling criteria data indicating preferred characteristics of subscribers.

9. A user association and communication device as recited in claim 8, wherein the user database is stored within the user association and communication device.

10. A user association and communication device as recited in claim 8, wherein the user database is stored on a central server.

11. A user association and communication device as recited in claim 8, wherein the user association and communication device is in communication with a central server having a subscriber database storing a plurality of subscriber data entries, each subscriber data entry including characteristics of a related subscriber.

12. A user association and communication device as recited in claim 11, wherein the central server facilitates a calling connection between at least two user association and communication devices based on the calling criteria data stored in a user database and characteristics stored in the subscriber database.

13. A user association and communication device as recited in claim 8, wherein the user database further includes data comprising contact data for individuals subscribers, and contact data for emergency services.

14. A user association and communication device as recited in claim 8, wherein the user association and communication device is capable of sending and receiving video and audio data to another user association and communication device.

15. A user association and communication device as recited in claim 8, wherein the video output module is connected to a monitor having the ability to display video image data during operation.

16. A user association and communication device as recited in claim 8, wherein a remote control device is associated with the user association and communication device, the remote control device including a microphone capable of providing audio data to the user association and communication device.

17. A method for associating individuals via a network medium, comprising:
storing a plurality of subscriber data indicating characteristics of individual subscribers;
storing a plurality of calling criteria data sets indicating preferred characteristics of subscribers, each calling criteria data set being associated with a requesting user;
selecting an individual subscriber having characteristics at least partially matching a calling criteria data set associated with the requesting user;
facilitating a calling connection between the selected individual subscriber and the requesting user.

18. A method as recited in claim 17, wherein the calling criteria associated with the requesting user is stored within a user database stored on a central server, the central server storing a plurality of user databases and the subscriber data.

19. A method as recited in claim 17, wherein the calling criteria associated with the requesting user is stored within a user database stored on a user association and communication device, wherein the user association and communication device is in communication with a central server storing the subscriber data.
